(19) United States
(12) Patent Application Publication
(10) Pub. No.: US 2006/0055259 A1
(43) Pub. Date: Mar. 16, 2006

(54) Fault-tolerant magnetic bearing position sensing and control system

(76) Inventors: Casey Hanlon, Queen Creek, AZ (US); Calvin C. Potter, Mesa, AZ (US); Paul T. Wingett, Mesa, AZ (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/941,179

(22) Filed: Sep. 14, 2004

(51) Int. Cl. H02K 7/09

(52) U.S. Cl. 310/90.5

(57) ABSTRACT

A magnetic bearing sensing and control system and method provides increased tolerance to faults associated with the associated displacement sensors. The system includes a plurality of redundant displacement sensor sets to provide dual or triple displacement sensor redundancy, or higher if desired, and implements a process for determining when one or more displacement sensors is faulty. The system also compensates for determined sensor-related faults.

### TECHNICAL FIELD

The present invention relates to magnetic bearings and, more particularly, to a fault-tolerant system and method for monitoring and controlling an active magnetic bearing system for use in various applications, including energy storage flywheels and other energy storage devices in both terrestrial and space applications.

### BACKGROUND

Magnetic bearings have been used to suspend a rotational body, such as a rotor, in a non-contact fashion using magnetic force. That is, instead of physically supporting the rotor using lubricated bearings that physically contact the rotor, various magnets are spaced radially around the rotor and the magnetic forces supplied by the magnets suspend the rotor without any physical contact. In order to provide stable support for the rotor, the magnetic bearing suspends the rotor within five degrees-of-freedom.

Generally, there are two categories of magnetic bearings, passive magnetic bearings and active magnetic bearings. Passive magnetic bearings are the simplest type, and use permanent magnets or fixed strength electromagnets to support the rotor. Thus, the properties of the bearing, such as the magnetic field strength, may not be controlled during operation. Conversely, active magnetic bearings are configured such that the magnetic field strength of the bearing is controllable during operation. To accomplish this, at least one active magnetic bearing channel may be provided for each degree-of-freedom of the shaft. An active magnetic bearing channel may include a position sensor, a controller operating according to a predetermined control law, and an electromagnet. In general, the position sensor senses the position of the shaft and supplies a signal representative of its position to the controller. The controller, in accordance with the predetermined control law, then supplies the appropriate current magnitude to the electromagnet, which in turn generates a magnetic force to correct the position of the shaft.

Although the above-described active magnetic bearing position sensing and control system generally works well, and is safe and reliable, it does suffer certain drawbacks. For example, if one or more of the position sensors is damaged, deteriorated, or otherwise experiences a fault, the faulty position sensor may supply inaccurate position information. This can cause, for example, the rotor to appear to be undergoing a non-circular rotation. This in turn can lead to inaccurate rotor position controls and, in some instances, can result in the controller exciting fundamental vibrations in the rotor or in the inability of the controller to keep the rotor rotating within the mechanical limits of the magnetic bearing.

Hence, there is a need for a fault-tolerant system and method of sensing and controlling one or more magnetic bearings. The present invention addresses at least this need.

### BRIEF SUMMARY

The present invention provides a fault-tolerant magnetic bearing position sensing and control system and method.

In one embodiment, and by way of example only, an active magnetic bearing sensing and control system for rotationally suspending a rotor that is configured to rotate about a rotational axis includes first and second primary displacement sensors, first and second secondary displacement sensors, and a controller. The first primary displacement sensor is configured to sense rotor displacements in a first axis that is perpendicular to the rotational axis and supply a displacement signal representative thereof. The second primary displacement sensor is configured to sense rotor displacements in a second axis that is perpendicular to the rotational axis and supply a displacement signal representative thereof. The first secondary displacement sensor is configured to sense rotor displacements in the first axis and supply a displacement signal representative thereof. The second secondary displacement sensor is configured to sense rotor displacements in the second axis and supply a displacement signal representative thereof. The controller is coupled to receive the displacement signals from each of the displacement sensors and a speed signal representative of a rotational speed of the rotor. The controller is operable, in response to receipt of the displacement signals and the speed signal, to determine operability of each of the displacement sensors.

In another exemplary embodiment, a method of determining the operability of a system that includes at least a rotor that is configured to rotate about a rotational axis, and one or more active magnetic bearings configured to rotationally suspend the rotor, includes the steps of sensing a first primary rotor displacement in a first axis that is perpendicular to the rotational axis, sensing a second primary rotor displacement in a second axis that is perpendicular to the rotational axis, sensing a first secondary rotor displacement in the first axis, sensing a second secondary rotor displacement in the second axis, and determining a rotational speed of the rotor. The validity of each of the sensed rotor displacements is determined based, at least in part, on the sensed rotor displacements and the determined rotational speed.

Other independent features and advantages of the preferred magnetic bearing sensing and control system will become apparent from the following detailed description, taken in conjunction with the accompanying drawings which illustrate, by way of example, the principles of the invention.

### BRIEF DESCRIPTION OF THE DRAWINGS

FIG. 1 is a perspective view of an exemplary active magnetic bearing control system according to an embodiment of the present invention;

FIG. 2 is a cross section view of a portion of the system shown in FIG. 1, taken along line 2-2 therein;

FIGS. 3-5 are cross sections similar to that shown in FIG. 2, but in accordance with various exemplary alternative embodiments; and

FIG. 6 is a flowchart depicting an exemplary process implemented by the exemplary system shown in FIG. 1.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention. In this regard, before proceeding with the detailed description, it is to be appreciated that the magnetic bearing system described herein is not limited to use with a particular configuration. Thus, although the magnetic bearing control system and method that is explicitly depicted and described is implemented using independent radial and axial bearing assemblies, it will be appreciated that other magnetic bearing configurations may also be used with the control system and method described herein. For example, the control system and method may also be used with a combination bearing configuration, or a conical bearing configuration.

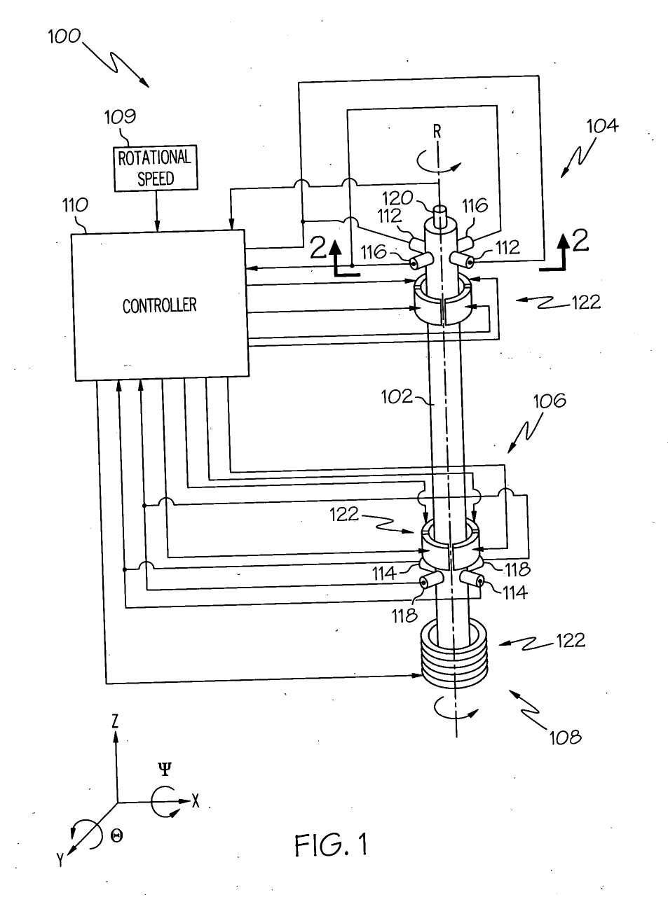

Turning now to the description, a simplified schematic and perspective view of an exemplary active magnetic bearing system 100 is depicted in FIG. 1. The system 100 includes a rotationally mounted rotor 102, two radial magnetic bearing assemblies 104 and 106, an axial magnetic bearing assembly 108, and a controller 110. The rotor 102, which has an axis of rotation R, is suspended by the magnetic bearing assemblies 104, 106, 108 and moves according to five degrees-of-freedom. These five degrees-of-freedom, as depicted in FIG. 1, include three lateral axes (X, Y, Z) and two rotational axes (theta (θ), psi (Ψ)).

The magnetic bearing assemblies 104, 106, 108, at least in the depicted embodiment, each include a plurality of electromagnets 122, which are used to eliminate rotor displacements. A plurality of displacement sensor sets 112-120 disposed proximate the rotor 102 are used to sense rotor displacements. Thus, together the displacement sensors 112-120 and electromagnets 122 sense and eliminate rotor displacements, respectively, to thereby control the position of the rotor 102 within the five degrees-of-freedom. In the depicted embodiment, the system 100 includes a total of ten electromagnets 122. Of this total, four electromagnets are used to eliminate rotor displacements in the x-axis and the T-axis, four electromagnets are used to eliminate rotor displacements in the y-axis and the θ-axis, and two electromagnets are used to eliminate rotor displacements in the z-axis. It will be appreciated that this number of actuators is merely exemplary of a particular embodiment and that more or less than this number of electromagnets may be included in the system 100.

In the depicted embodiment, the system 100 includes a total of five displacement sensor sets. Of this total, two x-axis displacement sensor sets, a first set 112 and a second set 114, sense rotor displacements in the x-axis, two y-axis displacement sensor sets, a first set 116 and a second set 118, sense rotor displacements in the y-axis, and one z-axis displacement sensor set 120 senses rotor displacements in the z-axis. It will be appreciated that this number of displacement sensor sets 112-120 is merely exemplary of a particular embodiment, and that various other numbers of displacement sensor sets could be used.

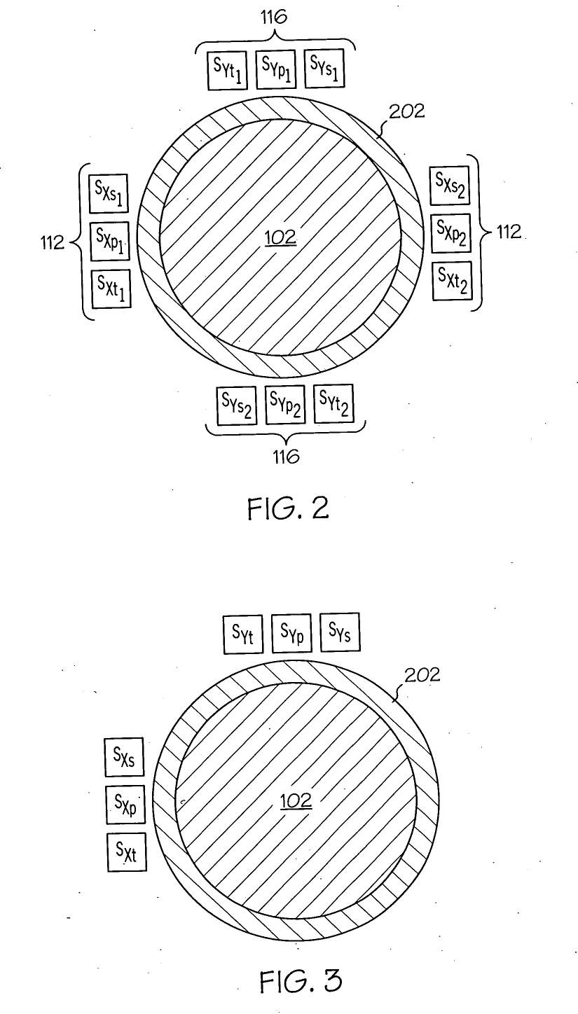

No matter the specific number of displacement sensor sets that are used, it will be appreciated that at least the x-axis and y-axis displacement sensor sets 112-118 each include a plurality of independent sensors, or a plurality of independent sensor pairs, depending on the particular sensor configuration being implemented. In the depicted embodiment, each of these displacement sensor sets 112-118 includes a plurality of independent sensor pairs. For example, as shown FIG. 2, which is a partial cross section view of the system 100 taken along line 2-2 in FIG. 1, the first x-axis displacement sensor set 112 includes three independent sensor pairs, a primary x-axis sensor pair (S_{Xp}), a secondary x-axis sensor pair (S_{Xs}), and a x-axis tertiary sensor pair (S_{Xt}), each of which includes two individual displacement sensors (S_{Xp1}, S_{Xp2}), (S_{Xs1}, S_{Xs2}), and (S_{Xt1}, S_{Xt2}), respectively. Similarly, the first y-axis displacement sensor set 116 includes three independent sensor pairs, a primary y-axis sensor pair (S_{Yp}), a secondary y-axis sensor pair (S_{Ys}), and a tertiary y-axis sensor pair (S_{Yt}), each of which includes two individual displacement sensors (S_{Yp1}, S_{Yp2}), (S_{Ys1}, S_{Ys2}), and (S_{Yt1}, S_{Yt2}), respectively. Though not explicitly depicted, it will be appreciated that the second x-axis and second y-axis displacement sensor sets 114 and 118, respectively, are similarly configured. Thus, the following description of the spacing, configuration, and functionality of the first x-axis and first y-axis displacement sensor sets 112 and 116, respectively, apply equally to the second x-axis and second y-axis displacement sensor sets 114 and 118, respectively.

As is clearly shown in FIG. 2, the individual sensors (S_{Xp1}, S_{Xp2}), (S_{Xs1}, S_{Xs2}), and (S_{Xt1}, S_{Xt2}) in each x-axis sensor pair (S_{Xp}), (S_{Xs}), and (S_{Xt}), respectively are disposed 180-degrees apart from one another, as are the individual displacement sensors (S_{Yp1}, S_{Yp2}), (S_{Ys1}, S_{Ys2}), and (S_{Yt1}, S_{Yt2}) in each y-axis sensor pair (S_{Yp}), (S_{Ys}), and (S_{Yt}), respectively. Moreover, in the depicted embodiment, each x-axis sensor pair (S_{Xp}), (S_{Xs}), and (S_{Xt}) is disposed orthogonal relative to its concomitant y-axis sensor pair (S_{Yp}), (S_{Ys}), and (S_{Yt}), respectively.

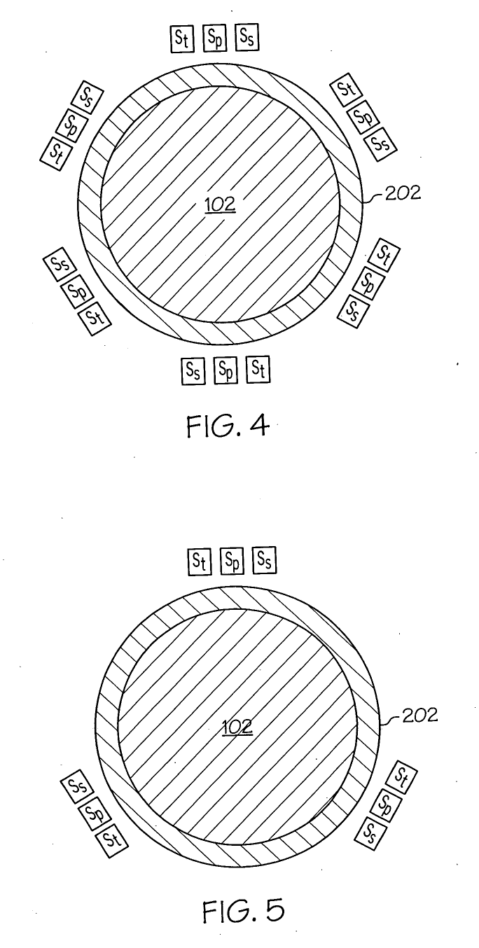

It will be appreciated that the above-described number, spacing, and configuration of the x-axis and y-axis sensor sets 112, 114 and 116, 118, respectively, is merely exemplary of a particular preferred embodiment, and that the number, spacing, and configuration of the individual x-axis and y-axis displacement sensors (S_{X}, S_{Y}) could differ from FIG. 2. For example, in one alternative embodiment shown in FIG. 3, the x-axis and y-axis sensor sets 112, 114 and 116, 118, respectively, could include, as was previously mentioned, a plurality of individual independent displacement sensors, rather than independent sensor pairs. In yet two other non-limiting alternative embodiments, rather than being implemented in a quadrature configuration, as in FIGS. 2 and 3, where the x-axis and y-axis sensor sets 112, 114 and 116, 118, respectively, are disposed at right angles relative to one another, three independent displacement sensors (FIG. 4) or displacement sensor pairs (FIG. 5) are evenly spaced around the periphery of the rotor 102.

It will additionally be appreciated that the individual x-axis and y-axis displacement sensors (S_{X}, S_{Y}) may be implemented using any one of numerous types of sensors now known, or developed in the future. In the depicted embodiment, however, the displacement sensors (S_{X}, S_{Y}) are each implemented as non-contact displacement sensors that sense the displacement between a portion of the displacement sensor (S_{X}, S_{Y}) and a suitable target. Non-limiting examples of this type of sensor include inductive sensors, eddy current sensors, Hall effect sensors, and capacitance sensors.

In the depicted embodiment, inductive sensors are used and, as is shown in FIGS. 2-6, a sensor target 202 is coupled to the rotor 102. In the preferred embodiment shown in FIG. 2, the target 202 is formed of a plurality of laminate sheets, and is coupled to the rotor 102. With this configuration, when the rotor 102 is rotating, the target 202 rotates past the individual x-axis and y-axis displacement sensors (S_{X}, S_{Y}) in a sensor pair (S_{Xp}, S_{Xs}, S_{Xt}) (S_{Yp}, S_{Ys}, S_{Yt}). The rotating target 202 acts similar to a transformer core, inductively coupling together each displacement sensor (S_{X}, S_{Y}) in a sensor pair (S_{Xp}, S_{Xs}, S_{Xt}) (S_{Yp}, S_{Ys}, S_{Yt}). It will be appreciated that other configurations could be used to implement the sensor target 202, depending on, for example, the type of the displacement sensors (S_{X}, S_{Y}) that are used.

With the above-described sensor implementations, as the rotor 102 rotates, the sensor target 202 rotates. As the sensor target 202 rotates, each sensor (S_{X}, S_{Y}) generates a displacement signal representative of the displacement between the sensor (S_{X}, S_{Y}) and the sensor target 202. In the preferred embodiment of FIG. 2, the individual displacement sensors (S_{X}, S_{Y}) in each sensor pair (S_{Xp}, S_{Xs}, S_{Xt}) (S_{Yp}, S_{Ys}, S_{Yt}) are configured as differential sensors. Thus, if the rotor 102 is displaced an equal amount from the individual displacement sensors (S_{X}, S_{Y}) in a sensor pair (S_{Xp}, S_{Xs}, S_{Xt}) (S_{Yp}, S_{Ys}, S_{Yt}), the displacement signal supplied from that sensor pair (S_{Xp}, S_{Xs}, S_{Xt}) (S_{Yp}, S_{Ys}, S_{Yt}) will be, for example, a zero voltage signal. It will be appreciated that a differential sensor configuration is merely exemplary, and that numerous other sensor configurations could also be used.

Returning once again to FIG. 1, it is seen that the displacement signals generated by each of the displacement sensor sets 112-120, and a rotational speed signal 109, are supplied to the controller 110. The controller 110 processes all of the displacement signals; however, in a particular preferred embodiment, the controller 110 implements a control law using only selected ones of the displacement signals and the rotational speed signal 109. For example, in the preferred embodiment, the controller 110 implements the control law using the displacement signals supplied from the primary sensor pair (S_{Xp} and S_{Yp}) in the x-axis displacement sensor sets 112, 114 and the y-axis displacement sensor sets 116, 118, respectively. However, if the displacement signals from one or more of the primary sensor pairs (S_{Xp} or S_{Yp}) are determined to be invalid, then the control law will use the displacement signals from either the secondary sensor pair (S_{Xs} or S_{Ys}) or the tertiary sensor pair (S_{Xt} or S_{Yt}) in the affected displacement sensor set 112, 114 or 116, 118, respectively. The process used to determine whether a displacement signal is valid or invalid is described in more detail further below.

In response to the displacement signals and preferably the rotational speed signal 109, the controller 110 selectively supplies rotor position command signals to the electromagnets 122 to eliminate unwanted rotor displacements. To do so, the controller 110 implements a control law, which may be any one of numerous magnetic bearing control laws now known or developed in the future. It will be appreciated that the rotational speed signal 109 may be supplied to the controller 110 from one or more speed sensors (not illustrated), or the controller 110 may derive the rotational speed signal 109 from one or more of the displacement signals using either the control law or a separate speed determination algorithm. In the depicted embodiment, the rotational speed signal 109 is derived from the displacement signals.

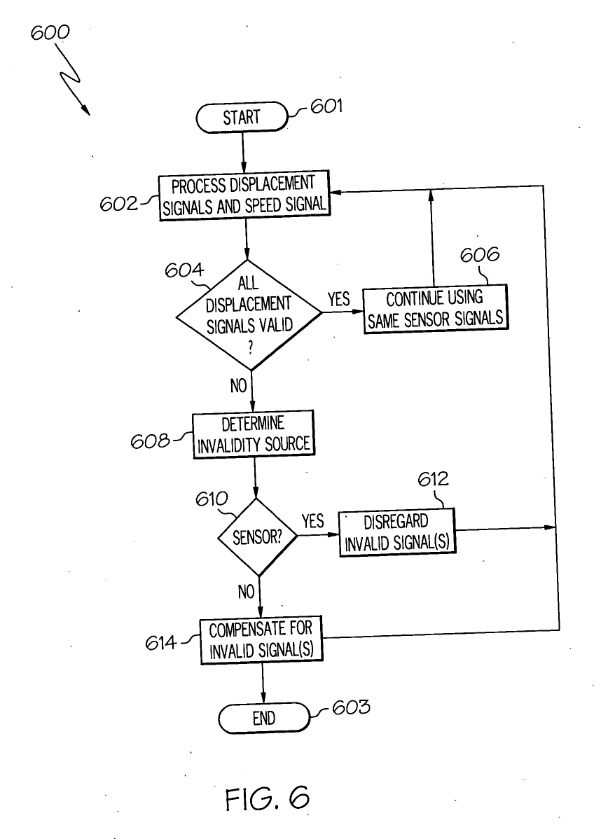

As was mentioned above, in addition to selectively supplying rotor position command signals to the electromagnets 122, the controller 110 also determines whether each of the displacement signals supplied to the controller 110 is valid or invalid, and the source of invalidity if it is so determined. A flowchart depicting a process implemented by the controller 110 to determine signal validity/invalidity, and the invalidity source, is shown in FIG. 6 and will now be described in more detail. In doing so, reference should be made, as necessary, to FIGS. 1 and 2 in combination with FIG. 6. Moreover, it should be noted that the parenthetical reference numerals in the following description correspond to like reference numerals that are used to reference the flowchart blocks in FIG. 6.

The signal validity process 600 begins by processing each of the displacement signals and the rotational speed signal 109 (602). The rotational speed signal 109, among other things, provides accurate phasing of the displacement signals supplied from each displacement sensor pair (S_{Xp}, S_{Xs}, S_{Xt}) (S_{Yp}, S_{Ys}, S_{Yt}) to actual rotor position. The processed displacement signals are then compared with one another and/or to one or more predetermined values to determine whether each signal is within a predetermined tolerance range of one another and/or a predetermined value range (604). If the displacement signals are all within the predetermined tolerance range and/or predetermined value range, then the displacement signals are all considered valid and the implemented control law continues using the same displacement signals, which are initially supplied by the primary sensor pairs (S_{Xp} and S_{Yp}) (606). The previous steps of the process X00 then repeat.

If, on the other hand, one or more of the displacement signals are outside the predetermined tolerance range and/or predetermined value range, those displacement signals are determined to be invalid and the source of the invalidity is determined (608). More specifically, the controller 110 determines whether the signal invalidity is due to a faulty displacement sensor (S_{X}, S_{Y}) or a faulty point, section, or area on the sensor target 202 (610). If a displacement sensor (S_{X}, S_{Y}) is faulty, then the displacement signal supplied from the displacement sensor pair (S_{Xp}, S_{Xs}, S_{Xt}) (S_{Yp}, S_{Ys}, S_{Yt}) that includes the faulty displacement sensor (S_{X}, S_{Y}) will continuously be invalid. If, however, a point, section, or area of the sensor target 202 is faulty, then the displacement signal supplied from each displacement sensor pair (S_{Xp}, S_{Xs}, S_{Xt}) (S_{Yp}, S_{Ys}, S_{Yt}) will be invalid only when the faulty point, section, or area of the sensor target 202 passes by the individual displacement sensor (S_{X}, S_{Y}) in the displacement sensor pairs (S_{Xp}, S_{Xs}, S_{Xt}) (S_{Yp}, S_{Ys}, S_{Yt}).

Once the source of signal invalidity is determined (608, 610), the controller 110 then takes the appropriate action to compensate for the invalidity source. In the depicted embodiment, if a displacement sensor (S_{X}, S_{Y}) is determined to be faulty, the control law will not use the displacement signal supplied from the faulty sensor pair (S_{Xp}, S_{Xs}, S_{Xt}) (S_{Yp}, S_{Ys}, S_{Yt}) and, if necessary, will switch to use of valid displacement signals supplied from a non-faulty displacement sensor pair (S_{Xp}, S_{Xs}, S_{Xt}) (S_{Yp}, S_{Ys}, S_{Yt}), or from a single non-faulty displacement sensor (S_{X}, S_{Y}) in a sensor pair (S_{Xp}, S_{Xs}, S_{Xt}) (S_{Yp}, S_{Ys}, S_{Yt}) (612). For example, if the control law is using the displacement signals supplied by the primary sensor pairs (S_{Xp} and S_{Yp}), and the displacement signal supplied by one of the primary sensor pairs (S_{Xp} or S_{Yp}) is determined to be invalid, then the control law will switch to the use of the displacement signals supplied by either the secondary sensor pair (S_{Xs} or S_{Ys}) or the tertiary sensor pair (S_{Xt} or S_{Yt}). Moreover, if the displacement signal is determined to be invalid after the control law has switched through each of the sensor pairs (S_{Xp}, S_{Xs}, S_{Xt}) (S_{Yp}, S_{Ys}, S_{Yt}), then the control law will use the displacement signal supplied from the single, non-faulty displacement sensor (S_{X}, S_{Y}) in the primary (S_{Xp} and S_{Yp}), secondary (S_{Xs} or S_{Ys}), or tertiary (S_{Xt} or S_{Yt}) sensor pair. In addition to switching the displacement signals used by the control law, the position readings from the faulty displacement sensor pair (S_{Xt} or S_{Yt}) are preferably disregarded, and not used in subsequent displacement signal comparisons (604).

Conversely, if a point, section, or area of the sensor target 202 is determined to be faulty, the control law is modified to compensate for the invalid displacement signals, and may thus continue using the invalid displacement signals (614). It will be appreciated that the control law may be modified in any one of numerous ways to compensate for the invalid displacement signals; however, in a preferred embodiment, one or more gains are adjusted. In addition to modifying the control law, the displacement signal comparisons (604) are also preferably modified to compensate for the invalid displacement signals. Once these modifications are implemented (614), the process 600 then repeats.

The magnetic bearing sensing and control system 100, and the associated process 600, described herein provides increased tolerance to faults associated with the associated displacement sensors. The system 100 implements dual or triple displacement sensor redundancy, or higher if desired, and a process 600 for determining when one or more displacement sensors is faulty. The process 600 also compensates for determined faults. Thus, the overall reliability of the system 100 is increased relative to known systems.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. An active magnetic bearing sensing and control system for rotationally suspending a rotor that is configured to rotate about a rotational axis, the system comprising:
a first primary displacement sensor configured to sense rotor displacements in a first axis that is perpendicular to the rotational axis and supply a displacement signal representative thereof;
a second primary displacement sensor configured to sense rotor displacements in a second axis that is perpendicular to the rotational axis and supply a displacement signal representative thereof;
a first secondary displacement sensor configured to sense rotor displacements in the first axis and supply a displacement signal representative thereof;
a second secondary displacement sensor configured to sense rotor displacements in the second axis and supply a displacement signal representative thereof; and
a controller coupled to receive the displacement signals from each of the displacement sensors and a speed signal representative of a rotational speed of the rotor, the controller operable, in response to receipt of the displacement signals and the speed signal, to determine whether each of the displacement signals is valid.

2. The system of claim 1, wherein the controller is further operable, in response to the displacement signals, to determine the rotational speed of the rotor and supply the speed signal representative thereof.

3. The system of claim 1, further comprising:
a rotational speed sensor operable to sense the rotational speed of the rotor and supply the speed signal representative thereof.

4. The system of claim 1, wherein the controller is further operable to selectively disregard one or more of the displacement signals based on the determined validity thereof.

5. The system of claim 1, wherein the controller is further operable to determine a cause of invalidity of one or more of the displacement signals.

6. The system of claim 1, wherein:
each displacement sensor comprises a displacement sensor set that includes a first individual displacement sensor and a second individual displacement sensor disposed in opposing relation to one another with the rotor interposed there between;
each individual displacement sensor in each displacement sensor set is configured to sense rotor displacements relative thereto and supply an individual sensor displacement signal representative thereof; and
each displacement signal is based on a difference between the individual sensor displacement signals associated with each individual displacement sensor in each displacement sensor set.

7. The system of claim 6, wherein the controller is further operable, in response to receipt of the displacement signals and the speed signal, to selectively disregard only one of the individual sensor displacement signals from one of the individual displacement sensors in each displacement sensor set.

8. The system of claim 1, further comprising:
a first tertiary displacement sensor configured to sense rotor displacements in the first axis and supply a displacement signal representative thereof; and
a second tertiary displacement sensor configured to sense rotor displacements in the second axis and supply a displacement signal representative thereof.

9. The system of claim 1, further comprising:
a sensor target coupled to the rotor,
wherein each displacement sensor senses rotor displacement based on a displacement between the displacement sensor and the sensor target.

10. The system of claim 1, wherein the controller is further operable, in response to receipt of the displacement signals and the speed signal, to determine whether one or more of the sensors is faulty or at least a portion of the sensor target is faulty.

11. The system of claim 10, wherein the controller is further operable, in response to the displacement signals and the speed signal, to (i) determine rotor position using a position determination algorithm and (ii) selectively supply rotor position command signals representative of a commanded rotor position based at least in part on the determined rotor position.

12. The system of claim 11, further comprising:
one or more electromagnets, each electromagnet coupled to receive one or more of the rotor position command signals and operable, in response thereto, to position the rotor to the commanded rotor position.

13. The system of claim 11, wherein, if the controller determines that at least a portion of the sensor target is faulty, the controller determines rotor position using an altered position determination algorithm.

14. The system of claim 11, wherein:
the first and second primary displacement sensors are disposed orthogonal relative to one another; and
the first and second secondary displacement sensors are disposed orthogonal relative to one another.

15. In a system including at least a rotor that is configured to rotate about a rotational axis, and one or more active magnetic bearings configured to rotationally suspend the rotor, a method of determining system operability, comprising the steps of:
sensing a first primary rotor displacement in a first axis that is perpendicular to the rotational axis;
sensing a second primary rotor displacement in a second axis that is perpendicular to the rotational axis;
sensing a first secondary rotor displacement in the first axis;
sensing a second secondary rotor displacement in the second axis;
determining a rotational speed of the rotor; and
determining a validity of each of the sensed rotor displacements based, at least in part on, the sensed rotor displacements and the determined rotational speed.

16. The method of claim 15, wherein the rotational speed is determined based at least in part on the sensed rotor displacements.

17. The method of claim 15, further comprising:
selectively disregarding one or more of the sensed rotor displacement signals based on the determined validity of each of the sensed rotor displacements.

18. The method of claim 15, further comprisings:
determining a cause of invalidity of one or more of the sensed rotor displacements.

19. The method of claim 15, wherein the sensed rotor displacements are generated using a sensor target coupled to the rotor, and a plurality of sensors, and wherein the method further comprises:
determining whether one or more of the sensors is faulty or at least a portion of the sensor target is faulty.

20. The method of claim 19, further comprising:
determining rotor position using a position determination algorithm; and
selectively supplying actuator position command signals representative of a commanded rotor position based at least in part on the determined rotor position.

21. The method of claim 20, further comprising:
determining rotor position using an altered position determination algorithm, if the sensor target is determined to be degraded.
